(19) United States
(12) Patent Application Publication
(10) Pub. No.: US 2022/0137751 A1
(43) Pub. Date: May 5, 2022

(54) DISPLAY SUBSTRATE, DISPLAY DEVICE, MANUFACTURING METHOD AND DRIVING METHOD FOR DISPLAY SUBSTRATE

(71) Applicants: BOE TECHNOLOGY GROUP CO., LTD., Beijing (CN); ORDOS YUANSHENG OPTOELECTRONICS CO., LTD., Ordos, Inner Mongolia (CN)

(72) Inventors: Zhengkui WANG, Beijing (CN); Zhen WANG, Beijing (CN); Jian SUN, Beijing (CN); Jian ZHANG, Beijing (CN)

(21) Appl. No.: 16/955,339

(22) PCT Filed: Jul. 26, 2019
(86) PCT No.: PCT/CN2019/097930

§ 371 Date: Jun. 18, 2020

(51) Int. Cl. G06F 3/044; G06F 3/041; G02F 1/1333

(52) U.S. Cl. CPC G06F 3/0446; G02F 1/13338; G06F 3/0412

(57) ABSTRACT

A display substrate, a display device, a manufacturing method of display substrate and a driving method of display substrate. The display substrate includes: a base substrate; a pixel array disposed on the base substrate; a plurality of gate lines extending in a first direction in the pixel array; a plurality of first touch electrodes disposed on the base substrate and extending in the first direction; a plurality of second touch electrodes disposed on the base substrate and located on a side of the plurality of first touch electrodes away from the base substrate, extending in a second direction crossing the first direction and intersecting the plurality of first touch electrodes; wherein the plurality of first touch electrodes and the plurality of gate lines are disposed in the same layer.

### TECHNICAL FIELD

Embodiments of the present disclosure relate to a display substrate, a display device, a manufacturing method and a driving method for display substrate.

### BACKGROUND

In the field of display technology, a pixel array of for example a liquid crystal display panel or an organic light emitting diode (OLED) display panel generally includes a plurality rows of gate lines and a plurality columns of data lines crossing gate lines. Driving of gate lines may be implemented by a bound integrated driving circuit. In recent years, with the continuous improvements of manufacturing process for amorphous silicon thin film transistors or oxide thin film transistors, it is also possible to integrate gate driving circuits directly on the array substrate of thin film transistors to form GOA (Gate driver on array) for driving gate lines. For example, it is possible to provide on/off state voltage signals (scan signals) for the plurality rows of gate lines of the pixel array with GOA including a plurality of cascaded shift register units so as to, for example, control the plurality rows of gate lines to be turned on successively and at the same time allow data lines to provide data signals to pixel units in corresponding row in the pixel array to generate grayscale voltages required for displaying grayscales of an image at the pixel units, thereby displaying a frame of image.

Touch screens may be classified into two classes according to the structure: add-on touch screens and one-piece touch screens. One-piece touch screens include on-cell touch screens and in-cell touch screens. In-cell touch screens are widely applied since they can reduce the overall thickness of the touch screen and the manufacturing costs of the touch screen.

### SUMMARY

At least one embodiment of this disclosure provides a display substrate, comprising: a base substrate; a pixel array disposed on the base substrate; a plurality of gate lines extending in a first direction in the pixel array; a plurality of first touch electrodes disposed on the base substrate and extending in the first direction; and a plurality of second touch electrodes disposed on the base substrate and located on a side of the plurality of first touch electrodes away from the base substrate, extending in a second direction crossing the first direction and intersecting the plurality of first touch electrodes; wherein the plurality of first touch electrodes and the plurality of gate lines are disposed in a same layer.

For example, in the display substrate provided in at least one embodiment of this disclosure, the pixel array comprises a plurality of pixel units, and each of the plurality of second touch electrodes covers at least two pixel units and is reused as a common electrode for the at least two pixel units.

For example, in the display substrate provided in at least one embodiment of this disclosure, at least one of the second touch electrodes comprise an opening disposed at a location where the at least one of the second touch electrodes intersects at least one of the first touch electrodes, and an orthogonal projection of the opening on the base substrate overlap at least partially an orthogonal projection of the at least one first touch electrodes on the base substrate.

For example, in the display substrate provided in at least one embodiment of this disclosure, further comprising a light blocking layer, wherein the light blocking layer is located on a side of the plurality of second touch electrodes away from the base substrate, orthogonal projections of the plurality of gate lines and orthogonal projections of the plurality of first touch electrodes on the base substrate all fall within an orthogonal projection of the light blocking layer on the base substrate.

For example, in the display substrate provided in at least one embodiment of this disclosure, orthogonal projections of gaps between adjacent two second touch electrodes of the plurality of second touch electrodes on the base substrate also fall within the orthogonal projection of the light blocking layer on the base substrate.

For example, in the display substrate provided in at least one embodiment of this disclosure, further comprising a plurality of data lines, wherein the plurality of data lines extend in the second direction in the pixel array, are located between the plurality of second touch electrodes and the plurality of first touch electrodes in a direction perpendicular to the base substrate, wherein orthogonal projections of gaps between adjacent two second touch electrodes of the plurality of second touch electrodes on the base substrate fall within orthogonal projections of the plurality of data lines on the base substrate respectively.

For example, in the display substrate provided in at least one embodiment of this disclosure, further comprising: a plurality of first touch electrode lines and a plurality of second touch electrode lines, the plurality of first touch electrode lines and the plurality of second touch electrode lines being disposed in a same layer as the data lines and extending in the second direction; wherein each of the plurality of first touch electrode lines is connected with at least one of the plurality of first touch electrodes, the plurality of second touch electrode lines are connected with the plurality of second touch electrodes, respectively.

For example, in the display substrate provided in at least one embodiment of this disclosure, further comprising a first insulating layer and a second insulating layer; wherein the first insulating layer is located between the plurality of first touch electrodes and the data lines in a direction perpendicular to the base substrate, and the plurality of first touch electrodes are connected with the plurality of first touch electrode lines through via holes in the first insulating layer, the second insulating layer is located between the data lines and the plurality of second touch electrodes in the direction perpendicular to the base substrate, and the plurality of second touch electrodes are connected with the plurality of second touch electrode lines through via holes in the second insulating layer.

For example, in the display substrate provided in at least one embodiment of this disclosure, the base substrate comprises a display area and a periphery area, the pixel array is located in the display area, and the pixel array comprises a plurality of sub-pixels arranged in an array along the first direction and the second direction; and wherein orthogonal projections of the plurality of first touch electrode lines and orthogonal projections of the plurality of second touch electrode lines on the base substrate do not overlap orthogonal projections of the sub-pixels in the display area on the base substrate, and are located between the orthogonal projections of the sub-pixels in the display area on the base substrate respectively.

For example, in the display substrate provided in at least one embodiment of this disclosure, the base substrate comprises a display area and a periphery area, the pixel array is located in the display area, and the pixel array comprises a plurality of sub-pixels arranged in an array along the first direction and the second direction; and wherein the plurality of first touch electrode lines and the plurality of second touch electrode lines are located in the peripheral area respectively.

For example, in the display substrate provided in at least one embodiment of this disclosure, orthogonal projections of the plurality of gate lines and orthogonal projections of the plurality of first touch electrodes on the base substrate do not overlap orthogonal projections of the sub-pixels in the display area on the base substrate, and are located between orthogonal projections of the sub-pixels in the display area on the base substrate along the first direction respectively.

For example, in the display substrate provided in at least one embodiment of this disclosure, further comprising: a binding area located on a side of the periphery area of the base substrate along the second direction; wherein the plurality of first touch electrode lines gradually become wider on a side away from the binding area in the second direction.

For example, in the display substrate provided in at least one embodiment of this disclosure, the plurality of first touch electrodes comprise a plurality of sets of first touch electrodes, each of the plurality sets of first touch electrodes comprises at least two first touch electrodes electrically connected with each other to be connected in parallel; and wherein at least one first touch electrode of the set of first touch electrode is connected with one of the plurality of first touch electrode lines.

For example, in the display substrate provided in at least one embodiment of this disclosure, the pixel array comprises M rows and N columns of pixel units, the display substrate comprises Q pieces of gate lines and Q pieces of first touch electrodes, and a gate line and a first touch electrode are disposed between every two adjacent rows of pixel units; the display substrate further comprises a plurality of dummy touch electrode lines disposed parallel with the plurality of first touch electrode lines, and each of the plurality of dummy touch electrode lines is connected with only one set of first touch electrodes, and the plurality of dummy touch electrode lines and the plurality of first touch electrode lines are disposed between columns of pixel units respectively; and wherein Q and N are both integers greater than or equal to 2.

At least one embodiment of this disclosure provides a display device comprising the display substrate of any one of claims 1-14.

At least one embodiment of this disclosure provides a manufacturing method of a display substrate, comprising: providing a base substrate; forming a pixel array on the base substrate; forming a first conducting layer on the base substrate, and forming a plurality of gate lines and a plurality of first touch electrodes extending in the first direction with one patterning process on the first conducting layer; and on a side of the plurality of first touch electrodes that is away from the base substrate, forming a plurality of second touch electrodes extending in a second direction crossing the first direction and intersecting the plurality of first touch electrodes.

For example, in the manufacturing method of a display substrate provided in at least one embodiment of this disclosure, further comprising: forming an opening on at least one of the plurality of second touch electrodes; wherein the opening is located at a location where the at least one of the second touch electrode and at least one of the first touch electrode intersects, an orthogonal projection of the opening on the base substrate overlap at least partially an orthogonal projection of the at least one of the first touch electrodes.

For example, in the manufacturing method of a display substrate provided in at least one embodiment of this disclosure, further comprising: forming a light blocking layer on the plurality of second touch electrodes, wherein orthogonal projections of the plurality of gate lines and orthogonal projections of the plurality of first touch electrodes on the base substrate all fall within an orthogonal projection of the light blocking layer on the base substrate.

For example, in the manufacturing method of a display substrate provided in at least one embodiment of this disclosure, further comprising: forming successively a first insulating layer, a second conducting layer and a second insulating layer in a direction perpendicular to the base substrate and between the plurality of first touch electrodes and the plurality of second touch electrodes; and forming a plurality of data lines, a plurality of first touch electrode lines and a plurality of second touch electrode lines extending in the second direction with one patterning process on the second conducting layer; wherein the data lines are located in the pixel array, and orthogonal projections of gaps between adjacent two second touch electrodes of the plurality of second touch electrodes on the base substrate fall within orthogonal projections of the data lines on the base substrate, each of the plurality of first touch electrode lines is connected with at least one of the plurality of first touch electrodes through a via hole in the first insulating layer, each of the plurality of second touch electrode lines is connected with the plurality of second touch electrodes through a via hole in the second insulating layer respectively.

For example, in the manufacturing method of a display substrate provided in at least one embodiment of this disclosure, the base substrate comprises a display area and a periphery area, the pixel array is located in the display area, and the pixel array comprises a plurality of sub-pixels arranged in an array along the first direction and the second direction, wherein forming a plurality of first touch electrode lines and a plurality of second touch electrode lines extending in the second direction on the second conducting layer in the periphery area of the base substrate.

At least one embodiment of this disclosure provides a driving method of the display substrate, comprising: in a display stage, providing gate scanning signals to the plurality of gate lines, and providing common signals to the second touch electrodes to drive the display substrate to display; and in a touch stage, providing touch driving signals to the plurality of second touch electrodes and receiving touch detection signals from the plurality of first touch electrodes.

### BRIEF DESCRIPTION OF DRAWINGS

In order to explain the technical solutions of the present invention more clearly, accompanying drawings of embodiments will be described in brief below. It is obvious that the below described drawings only relate to some embodiments of the present invention rather than limiting the present invention.

FIG. 1 is a plan view of a display substrate according to at least one embodiment of the present disclosure;

FIG. 2 is a circuit structure diagram of an individual sub pixel according to at least one embodiment of the present disclosure;

FIG. 3 is a plan view of routing of the display substrate shown in FIG. 1;

FIG. 4A is a plan view of another display substrate according to at least one embodiment of the present disclosure;

FIG. 4B is a sectional view along A-K direction on the display substrate shown in FIG. 4A;

FIG. 4C is a sectional view of another display substrate according to at least one embodiment of the present disclosure;

FIG. 5 is a plan view of routing of the display substrate shown in FIG. 4A;

FIG. 6 is a schematic diagram of a display device according to at least one embodiment of the present disclosure; and

FIG. 7 is a flow chart of a method for manufacturing a display substrate according to at least one embodiment of the present disclosure.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

The present disclosure will be described below with several specific embodiments. In order to keep the following description of embodiments of the present invention clear and concise, detail description of known functions and known components may be omitted. When any component in embodiments of the present invention appears in more than one drawings, the component is denoted with the same reference number in every drawing.

At present, people desire narrow rim designs more and more for mobile devices such as mobile phones and tablet computers. However, it is difficult to further reduce rims of display panels under prior art manufacturing process such as 9Mask process, namely the manufacturing process using 9 mask processes. For example, for a full in cell touch screen, the routing width for its fan lead such as touch lines is an important factor that influence rim width of a display panel. For example, the number of touch channels of a traditional full-in-cell touch screen is number of rows*number of columns. Therefore, large amount of lines at the bottom rim of the full-in-cell touch screen is adverse to narrow-rim design.

At least one embodiment of the present disclosure provides a display substrate including: a base substrate; a pixel array disposed on the base substrate; a plurality of gate lines extending in a first direction in the pixel array; a plurality of first touch electrodes disposed on the base substrate and extending in the first direction; a plurality of second touch electrodes disposed on the base substrate on a side of the base substrate kept away by the plurality of first touch electrodes, extending in a second direction crossing the first direction and crossing the plurality of first touch electrodes; wherein the plurality of first touch electrodes are disposed in the same layer as the gate lines.

At least one embodiment of the present disclosure further provides a display device corresponding to the above-described display substrate and a manufacturing method and a driving method for the display substrate.

With the display substrate provided in the above-described embodiments of the present disclosure, by disposing gate lines and first touch electrodes such as touch detection electrodes in the same layer, it is possible to reduce conducting layers for manufacturing touch electrodes separately, simplify manufacturing process and reduce manufacturing costs. At the same time, in other embodiments of the present disclosure, it is further possible to form mutual capacitance between the common electrode layer and the gate line layer such that the number of touch channels of the display substrate may be reduced to the number of rows plus the number of columns, which significantly reduces the number of touch channels, reduces the number of touch routing lines at bottom rim of the display panel and shrink the rim.

Detail description of embodiments of the present disclosure and examples thereof will be presented below with reference to figures.

At least one embodiment of the present disclosure provides a display substrate that may be for example, a liquid crystal display substrate (LCD), which may be of for example, in-plane switching (IPS), fringe field switching (FFS), twisted nematic (TN) and vertical alignment (VA), which is not limited in embodiments of the present disclosure. The display substrate may implement touch and display performance.

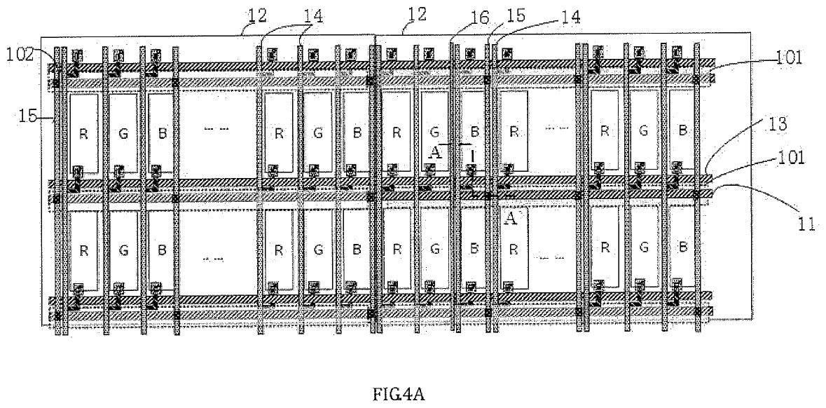

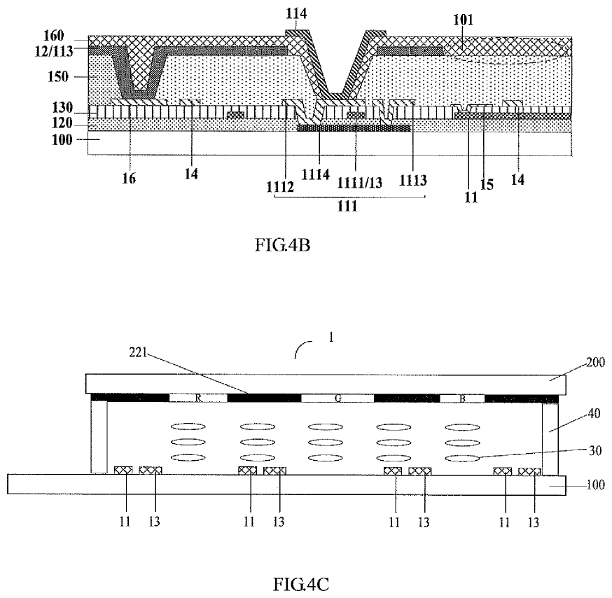

FIG. 1 is a plan view of a display substrate according to at least one embodiment of the present disclosure, and FIG. 4A is a plan view of another display substrate according to at least one embodiment of the present disclosure. The display substrates shown in FIGS. 1 and 4A have similar structures except for the following differences. In the display substrate shown in FIG. 1, the first touch electrode lines connected to the first touch electrodes and the second touch electrode lines connected to the second touch electrodes are located at the periphery area of the base substrate (not shown in the figure). In the display substrate shown in FIG. 4A, the first touch electrode lines 15 connected to the first touch electrodes 11 and the second touch electrode lines 16 connected to the second touch electrodes 12 are located in the display area of the base substrate 100, namely in the pixel array. FIG. 4B is a sectional view along A-K direction on the display substrate shown in FIG. 4A and of course may be used to explain the structure of the display substrate shown in FIG. 1 in the A-K direction. The display substrates provided in embodiments of the present disclosure will be described in detail below with reference to FIGS. 1, 4A and 4B.

As shown in FIG. 1, the display substrate includes a base substrate 100, and a pixel array 110, a plurality of gate lines 13, a plurality of first touch electrodes 11 and a plurality of second touch electrodes 12 (for example, two second touch electrodes are illustratively shown in the figure) disposed on the base substrate 100.

For example, the base substrate 100 may be of for example, glass, plastic, quartz or other suitable material, which is not limited in embodiments of the present disclosure.

For example, the base substrate 100 includes a display area and peripheral areas (not shown in the figure), and the pixel array 110 is in the display area of the base substrate 100.

For example, the pixel array 110 includes a plurality of pixel units P arranged in an array. For example, considering the display substrate (an array substrate herein) for a liquid crystal display device as an example, the plurality of gate lines 13 and the plurality of data lines 14 are arranged in an array and cross each other to define a plurality of sub-pixels. For example, each of the plurality of pixel units P includes red, green and blue (RGB) sub-pixels in the same row, that is, the pixel array 110 includes a plurality of sub-pixels arranged in the first direction and the second direction.

For example, the pixel array includes M rows and N columns of pixel units, the display panel includes Q gate lines and Q first touch electrodes, and a gate line and a first touch electrode are disposed between every two adjacent rows of pixel units. This is not limited in embodiments of the present disclosure.

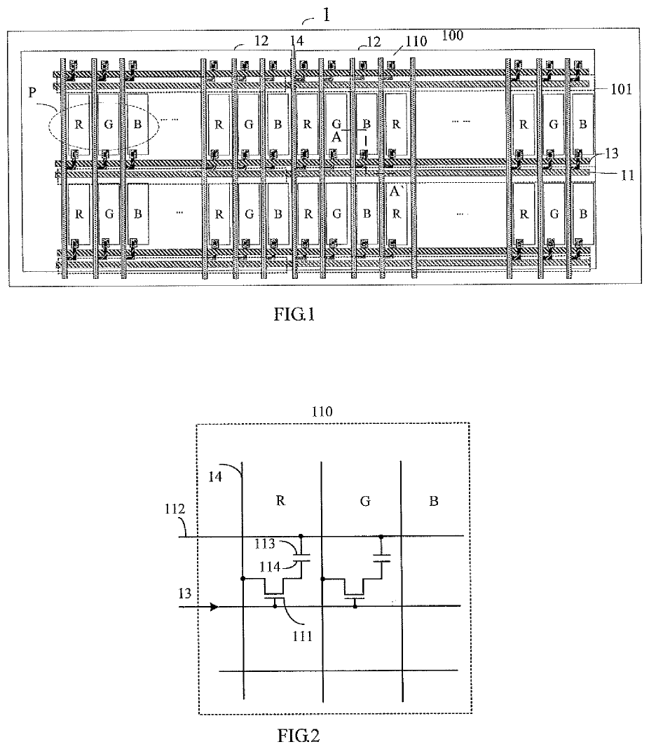

FIG. 2 shows a circuit structure diagram of an individual sub-pixel. As shown in FIG. 2, each sub-pixel includes at least one thin film transistor 111, a pixel electrode 114 and a common electrode 113. As a switch element, the thin film transistor 111 is connected with the gate line 13, the data line 14 and the pixel electrode 114 respectively and the pixel electrode 114 and the common electrode 113 form a capacitor. For example, the common electrode 113 and the common electrode line 112 are connected to receive common electrode signals. The thin film transistor 111 in turned on under the control of gate scanning signals on the gate line 13 and applies data signals on the data line 14 to the pixel electrode 114 to charge the capacitor formed by the thin film transistor 111 and the common electrode 113, thereby forming an electric field for controlling deflection of ligates.

For example, the thin film transistors 111 in the pixel array 110 may be manufactured with conventional semiconductor manufacturing process. In some examples, for example, as shown in FIG. 4B, first, the active layer 1114 of the thin film transistor 111 is formed on the base substrate; and the first passivation layer 120, the gate 1111 (connected with or formed integral with gate line 13), the first insulating layer 130, the first terminal 1112 (e.g. source) and the second terminal 1113 (e.g. drain) of the thin film transistor 112, the second insulating layer 150, the common electrode 113 or the second touch electrode 12, the third insulating layer 160 and the pixel electrode 114 are formed sequentially on the active layer 1114.

In some examples, the gate 1111 of the thin film transistor 111 is connected with the gate driving circuit (not shown) via the gate line 13 (e.g., formed integral with the gate 1111) to receive gate scanning signals, and the first terminal 1112 and the second terminal 1113 of the thin film transistor 111 are connected through a via hole in the first passivation layer 120 and the first insulating layer 130. For example, the first terminal 1112 of the thin film transistor 111 is connected with the data line 14 (shown in FIG. 1 or 4A), and connected with the pixel electrode 114 through a via hole in the second insulating layer 150 and the third insulating layer 160 to transmit data signals provided by the data line 14 to the pixel electrode 114 when the thin film transistor 111 is turned on under the control of the gate scanning signals, thereby generating an electric field between the pixel electrode 114 and the common electrode 113 for controlling deflection of liquid crystalline over or between them.

For example, the pixel electrode 114 and the common electrode 113 (namely the second touch electrode) are transparent electrodes that may use transparent metal oxide material including indium tin oxide (ITO) or indium zinc oxide (IZO).

For example, materials for the first terminal 1112, the second terminal 1113 and the gate 1111 of the thin film transistor 111 may include aluminum, aluminum alloy, copper, copper alloy or any other suitable materials, which are not limited in embodiments of the present disclosure. For example, the plurality of first touch electrodes 11 and the plurality of gate lines 13 have the same material as the gate 1111, which will not be described any more herein.

For example, in some embodiments of the present disclosure, material for the active layer 1114 is low temperature poly-silicon. It is to be noted that the material for the active layer may also include oxide semiconductor, organic semiconductor or amorphous silicon, high temperature poly-silicon etc. For example, the oxide semiconductor includes metal oxide semiconductor such as indium gallium zinc oxide (IGZO). This is not limited in embodiments of the present disclosure.

For example, materials for the first passivation layer 120, the first insulating layer 130, the second insulating layer 150 and the third insulating layer 160 may include for example include inorganic insulating material such as SiNx, SiOx and SiNxOy, organic insulating material such as organic resin or other suitable materials, which are not limited in embodiments of the present disclosure.

For example, as shown in FIG. 1, the plurality of gate lines 13 extend in the first direction (e.g., the lateral direction shown in FIG. 1) in the pixel array 110 to provide gate scanning signals to thin film transistors 111 of sub-pixels connected therewith.

For example, the plurality of first touch electrodes 11 are disposed on the base substrate 100 and extend in the first direction, that is, the plurality of first touch electrodes 11 and the plurality of gate lines 13 are parallel. The plurality of first touch electrodes 11 and the plurality of gate line 13 are disposed in the same layer, and may be for example formed with one patterning process, thereby reducing the conducting layer for manufacturing the first touch electrodes separately, omitting a manufacturing process and reducing manufacturing costs. For example, the plurality of first touch electrodes 11 and the plurality of gate lines 13 may be manufactured with conventional patterning process, which will not be described any more herein.

For example, in some examples, the number of the first touch electrodes may be the same as the number of the gate lines. That is, as shown in FIG. 1, each row of pixel units P correspond to one gate line 13 and one first touch electrode 11, which may improve touch accuracy. In some other embodiments, the number of the first touch electrodes may also be different from the number of the gate lines. For example, it is possible to dispose one first touch electrode for every third row of pixel units P, which may be determined depending on actual conditions as long as the touch function of the display substrate is not influenced.

For example, as shown in FIG. 1, the plurality of gate lines 13 and the plurality of first touch electrodes 11 are located between rows of pixel units, that is, orthogonal projections of the plurality of gate lines 13 and orthogonal projections of the plurality of first touch electrodes on the base substrate 100 do not overlap the orthogonal projections of sub-pixels in the display area on the base substrate 100, and are located between the orthogonal projections of the sub-pixels in the display area in the first direction on the base substrate 100, for example, located between the orthogonal projections of the pixel electrodes of the sub-pixels in the display area on the base substrate 100 in the first direction.

In some examples, as shown in FIG. 4B, the plurality of second touch electrodes 12 are disposed on the base substrate 100 and located on a side of the plurality of first touch electrodes 11 that is away from the base substrate 100, that is, above the plurality of first touch electrodes 11, and extend in the second direction crossing the first direction (e.g., the longitudinal direction shown in FIG. 1) and intersect the plurality of first touch electrodes 11. For example, mutual capacitance is formed at locations where the plurality of second touch electrodes 12 intersect the plurality of first touch electrodes 11, and touch positions of a finger or stylus are determined by detecting the varying point of the mutual capacitance. For example, the first touch electrodes 11 serve as touch detection electrodes for transmitting touch detection signals; and the second touch electrodes serve as touch driving electrodes for transmitting touch driving signals.

For example, as shown in FIGS. 1 and 2, each second touch electrode covers at least two pixel units and is reused as the common electrode for the at least two pixel units. For example, the number of pixel units to which each second touch electrode corresponds may be the same or different, which is not limited in embodiments of the present disclosure. For example, in some examples, as shown in FIGS. 1 and 4A, one second touch electrode 12 corresponds to tens or hundreds of sub-pixel units (including red sub-pixel units R, green sub-pixel units G and blue sub-pixel units B), which is not limited in embodiments of the present disclosure. FIG. 1 or 4A schematically illustrates only two rows of pixel units, which is not limited in embodiments of the present disclosure, and may further include more rows of pixel units. For example, the display stage and touch stage of the display substrate may be driven in a time division manner. For example, when the display substrate 1 is in the display stage, the plurality of second touch electrodes may serve as common electrode to receive common signals on the common signal line 112 for driving the display substrate to display; and when the display substrate 1 is in the touch stage, the plurality of second touch electrodes may receive touch driving signals for touch detection.

For example, in some examples, the touch stage may be inserted in the blanking stage between adjacent two frames of displayed images to drive the display substrate 1 to implement display function and touch function respectively. In this case, the touch report rate of the touch screen is the same as the display frame rate, for example both are 60 Hz. For example, in some other examples, it is also possible to insert a plurality of touch stages piecewise in a display stage of a frame of image to improve the touch report rate (e.g., up to 120 Hz). For example, the driving of the above-described display stage and touch stage may be implemented by controlling the driving timing and circuit structure of the gate driving circuit. It is to be noted that specific circuit and driving method for implementing the display and touch functions of the display substrate may be known from design methods in the art, which will not be described any more herein.

With the display substrate provided in at least one embodiment of the present disclosure, by forming the second touch electrodes on the common electrode layer and forming the first touch electrodes on the gate line layer to form mutual capacitance, it is possible to reduce the number of touch channels of the display substrate to the number of rows+the number of columns. As compared to the number of touch channels of a traditional touch panel (number of rows*number of columns), the display substrate significantly reduces the number of touch channels, reduces the number of touch lines at bottom rim of the display panel and shrink the rim.

In some examples, as shown in FIG. 1, at least one second touch electrode 12 intersects at least one first touch electrode 11, and at least one second touch electrode 12 further includes openings 101 disposed at locations where the at least one second touch electrode 12 intersects the at least one first touch electrode 11. For example, as shown in FIGS. 1 and 4A, each second touch electrode 12 may be provided with openings at all locations where it intersects the plurality of first touch electrodes 12. Of course, it is also possible to dispose openings at partial locations where it intersects the plurality of first touch electrodes 12. That is, openings are not disposed at all intersecting locations as long as it is ensured that the display substrate 1 can accurately implement touch function, which is not limited in embodiments of the present disclosure.

For example, as shown in FIG. 4B, the orthogonal projections of the openings 101 on the base substrate 100 overlap at least partially the orthogonal projections of the at least one first touch electrodes 11 on the base substrate. For example, by disposing openings 101 at locations where the second touch electrodes intersect the first touch electrodes, it is possible to allow the second touch electrodes on both sides of the opening 101 to form mutual capacitance with the first touch electrode 11, thereby enhancing mutual capacitance and improving sensitivity. And the electric field associated with the mutual capacitance may exit through the openings 101 to be acted on by a finger of human or a stylus, thereby improving the sensitivity of sensing touch by mutual capacitance, which allows accurately sensing or detecting a finger or stylus to implement touch function.

For example, in at least one example, the display substrate 1 may further include a light blocking layer (not shown in FIG. 4B). For example, the light blocking layer is located on a side of the plurality of second touch electrodes 12 that is away from the base substrate 100, that is, the light blocking layer is located above the second touch electrodes 12. For example, the light blocking layer may be formed above a layer of the base substrate 100 in which the plurality of second touch electrodes are located, or on the opposed substrate of the base substrate 100 (as shown in FIG. 4C), which is not limited in embodiments of the present disclosure. For example, the orthogonal projections of the plurality of gate lines 13 and orthogonal projections of the plurality of first touch electrodes 11 on the base substrate 100 all fall within the orthogonal projection of the light blocking layer on the base substrate.

As shown in FIG. 4C, the display substrate 1 includes a base substrate 100 and an opposed substrate 200 disposed oppositely and a liquid crystal layer 30 is provided between the base substrate 100 and the opposed substrate 200, which are combined together with e.g., sealing glue 40 to form a liquid crystal cell. The opposed substrate 200 is typically a color filter substrate on which a color filter layer including red sub-pixels R, green sub-pixels G and blue sub-pixels B may be disposed. Individual sub-pixels are separated by the light blocking layer 221 (e.g., the black matrix in display area).

For example, for clear and concise description, only a plurality of first touch electrodes 11 and a plurality of gate line 3 are illustrated in the base substrate 100 shown in FIG. 4C, FIG. 4B may be referred to for other structures on the base substrate 100, which will not be described any more herein. For example, a touch chip (not shown) is further disposed on the base substrate 100. The first touch electrodes 11 and the second touch electrodes 12 are connected with the touch chip via routing lines respectively. The touch chip may determine a touch position by detecting the variation of capacitance of a plurality of mutual capacitances formed between the plurality of first touch electrodes 11 and the plurality of second touch electrodes 12 in a scanning manner.

For example, in order to prevent transmitted visible light from entering the display substrate through gaps between two adjacent second touch electrodes of the plurality of second touch electrodes 12 and influencing the display performance, the orthogonal projections of gaps between two adjacent second touch electrodes of the plurality of second touch electrodes 12 on the base substrate also fall within the orthogonal projection of the light blocking layer 221 on the base substrate.

For example, the light blocking layer 221 may include opaque materials such as metal electrodes, dark resin and so on, which function to block light for the plurality of gate lines 13, the plurality of first touch electrodes 11 and gaps between two adjacent second touch electrodes of the plurality of second touch electrodes 12, thereby avoiding influence of transmitted visible light on its performance.

For example, as shown in FIG. 1 or 4, the display substrate 1 further includes a plurality of data lines 14. For example, the plurality of data lines 14 extend in a second direction in the pixel array 110, that is, the plurality of data lines 14 and the plurality of second touch electrodes 12 are parallel.

For example, the plurality of data lines 14 are between the plurality of second touch electrodes 12 and the plurality of first touch electrodes 11 in the direction perpendicular to the base substrate 100, that is, the layer in which the plurality of data line 14 are located is between the layer in which the plurality of second touch electrodes 12 are located and the layer in which the plurality of first touch electrodes 11 are located in the direction perpendicular to the base substrate 100. For example, as shown in FIG. 1, the orthogonal projections of gaps between two adjacent second touch electrodes of the plurality of second touch electrodes 12 on the base substrate fall within the orthogonal projections of the plurality of data lines on the base substrate 100 respectively, thereby preventing light from the backlight under the base substrate 100 from illuminating the opposed substrate 200 through gaps between two adjacent second touch electrodes and influencing the display quality.

For example, as shown in FIG. 4A, the display substrate 1 further includes: a plurality of first touch electrode lines 15 (not shown in FIG. 1) and a plurality of second touch electrode lines 16 (for clear and concise description, FIG. 4A schematically illustrates only one piece of second touch electrode line 16). For example, the plurality of first touch electrode lines 15 and the plurality of second touch electrode lines 16 are disposed in the same layer as data lines 14 and extend in the second direction. For example, materials for the plurality of second touch electrodes 12 and the data lines 14 are the same as the material for the first terminal 1112, the second terminal 1113 of the thin film transistor 111, which will not be described any more herein.

For example, each of the plurality of first touch electrode lines 15 is connected with at least one of the plurality of first touch electrodes 11.

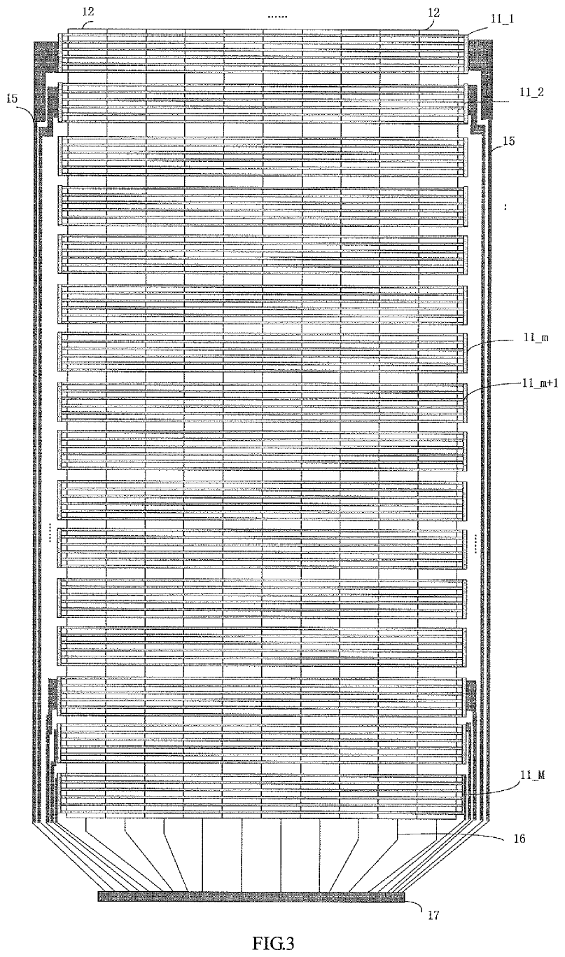

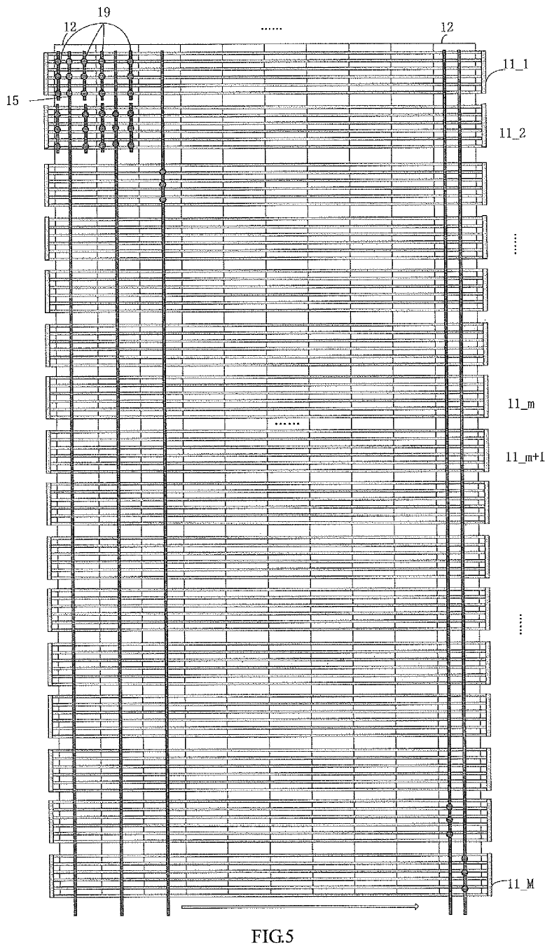

FIG. 3 is a plan view of routing of the display substrate shown in FIG. 1; and FIG. 5 is a plan view of routing of the display substrate shown in FIG. 4A. For example, as shown in FIGS. 3 and 5, the plurality of first touch electrodes 11 are electrically connected with each other to be connected in parallel to form a set of first touch electrodes (for example, the display substrate 1 includes M sets of first touch electrodes 11_1, 11_2, . . . 11_m, 11_m+1, . . . , 11_M), wherein M and m are both positive integers and M>m. For example, at least one touch electrode 11 of the set of first touch electrode is connected with one of the plurality of first touch electrode lines 15. It is to be noted that one first touch electrode 11 may also be connected with a plurality of first touch electrode lines 15 to guarantee the transmission of touch detection signals, which is not limited in embodiments of the present disclosure.

In some examples, as shown in FIG. 3, the plurality of first touch electrode lines 15 and the plurality of second touch electrode lines 16 may be located in peripheral areas of the base substrate 100. For example, in the example shown in FIG. 3, one first touch electrode in the set of first touch electrode 11_1 is connected with the first touch electrode line and one first touch electrode in the set of first touch electrodes 11_2 is connected with the second first touch electrode line, and so on.

In some other examples, as shown in FIGS. 4A and 5, the plurality of first touch electrode lines 15 and the plurality of second touch electrode lines 16 may be located in the pixel array 110, namely in the display area of the base substrate 100, which can further reduce the left and right rim of the display substrate. For example, in the example shown in FIG. 5, each first touch electrode in the set of first touch electrodes can be connected with one first touch electrode line through a via, and of course, one first touch electrode line may also be connected with 2 or more first touch electrodes of any number in the set of first touch electrodes through via holes, which is not limited in embodiments of the present disclosure.

In some examples, as shown in FIG. 5, the plurality of first touch electrode lines 15 may run through both sides of the display panel to ensure the consistency of display of the display panel.

In some other examples, as shown in FIG. 5, the display panel further includes a plurality of dummy touch electrode lines 19 disposed parallel with the plurality of first touch electrode lines 15. For example, the plurality of dummy touch electrode lines are disposed piecewise and each of the plurality of dummy touch electrode lines 19 is connected with only one set of first touch electrodes. For example, the plurality of dummy touch electrode lines 19 and the plurality of first touch electrode lines 15 are disposed between columns of pixel units respectively. For example, one or more dummy touch electrode lines may be disposed between every two adjacent columns of pixel units, which is not limited in embodiments of the present disclosure. In embodiments of the present disclosure, disposing dummy touch electrode lines can ensure consistent openings for pixel units and enhance display uniformity of the display panel.

In this embodiment, dividing the plurality of first touch electrodes 11 into a plurality of sets of first touch electrodes each including a plurality of (e.g., at least two) first touch electrodes 11 electrically connected with each other to be connected in parallel such that touch signals detected by the plurality of first touch electrodes in a set of first touch electrodes are transmitted through one first touch electrode line, which can effectively reduce the number of touch channels and facilitate reduction of rims of display screens.

For example, each of the plurality of second touch electrode lines 16 is connected with a plurality of second touch electrodes 12 respectively.

For example, the plurality of first touch electrodes 11 are connected with the above-described touch chip through a plurality of first touch electrode lines 15 to transmit touch detection signals to the touch chip, the plurality of second touch electrodes 12 are connected with the above-described touch chip through a plurality of second touch electrode lines 16 to receive touch driving signals provided by the touch chip, thereby implementing touch function.

In some examples, as shown in FIG. 4B, the first insulating layer 130 is located between the plurality of first touch electrodes 11 and the data lines 14 in the direction perpendicular to said base substrate, and the plurality of first touch electrodes 11 are connected with the plurality of first touch electrode lines 15 through via holes in the first insulating layer 130 to transmit touch detection signals; the second insulating layer 150 is located between the data lines 14 and the plurality of second touch electrodes 12 in the direction perpendicular to the base substrate and the second touch electrodes 12 are connected with a plurality of second touch electrode lines 16 (not shown in FIG. 4A, and schematically shown in FIG. 4B for clarity) through via holes in the second insulating layer 150 to transmit touch driving signals.

For example, as shown in FIG. 4A, when the plurality of first touch electrode lines 15 and the plurality of second touch electrode lines (not shown) are located in the pixel array 110, the orthogonal projections of the plurality of first touch electrode lines 15 and orthogonal projections of the plurality of second touch electrode lines (not shown) on the base substrate 100 do not overlap the orthogonal projections of sub-pixels in the display area on the base substrate 100, for example, do not overlap the orthogonal projections of red sub-pixels R, green sub-pixels G and blue sub-pixels B defined by intersections between the plurality of gate lines 13 and the plurality of data lines 14 shown in FIG. 4A in the display area on the base substrate 100, and the plurality of first touch electrode lines 15 and the plurality of second touch electrode lines (not shown) are located between orthogonal projections of sub-pixels in the display area on the base substrate 100 respectively. For example, the plurality of first touch electrode lines 15 and the plurality of second touch electrode lines (not shown) are located between orthogonal projections of pixel electrodes of the above-described sub-pixels on the base substrate 100 respectively, thereby preventing the first touch electrode lines and the second touch electrode lines from blocking light from sub-pixels and hence influencing the display of the display panel.

In some examples, the display substrate 1 further includes a binding area 17 (for electrically connecting touch chip etc.) on a side of the periphery area of the base substrate along the second direction, e.g., lower side of the display substrate.

When the first touch electrode lines 15 and the second touch electrode lines 16 are located in the periphery area, since the farther from the binding area, the less of lines, for example, as shown in FIG. 3, the plurality of first touch electrode lines 15 are gradually becoming wider in the second direction on the side away from the binding area, to maintain consistent resistance of touch electrode lines away from the binding area and near the binding area and enhance touch accuracy.

With the display substrate provided in said at least one embodiment of the present disclosure, by disposing gate lines and the first touch electrodes (such as touch detection electrodes) in the same layer, it is possible to reduce conducting layers for manufacturing touch electrodes separately, simplify manufacturing process and reduce manufacturing costs. In at least one embodiment of the present disclosure, by forming the second touch electrodes on the common electrode layer and forming the first touch electrodes on the gate line layer to form mutual capacitance, it is possible to reduce the number of touch channels of the display substrate to the number of rows+the number of columns, which significantly reduces the number of touch channels, reduces the number of touch lines at bottom rim of the display panel and shrink the rim.

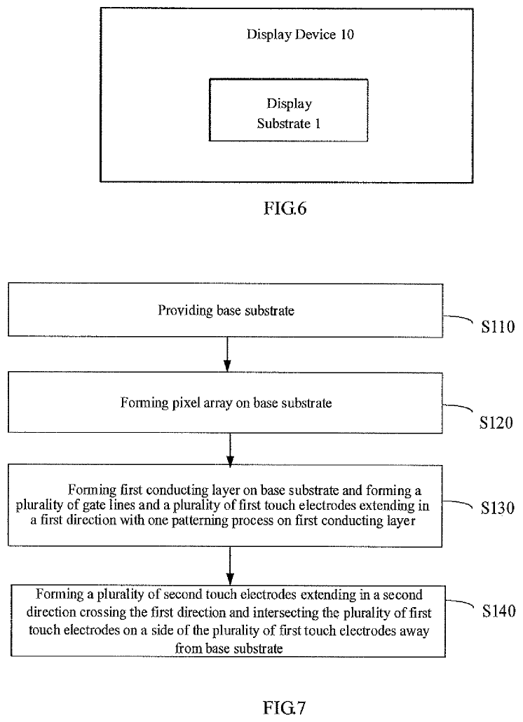

At least one embodiment of the present disclosure further provides a display device. FIG. 6 is a schematic diagram of a display device according to at least one embodiment of the present disclosure. As shown in FIG. 6, the display device 10 includes the display substrate 1 provided in any embodiment of the present disclosure, e.g., the display substrate 1 shown in FIG. 1 or 4A.

For example, the display device may be a liquid crystal display device. For example, the liquid crystal display device may be of for example, in-plane switching (IPS), fringe field switching (FFS), twisted nematic (TN) and vertical alignment (VA), which is not limited in embodiments of the present disclosure.

It is to be noted that for clear and concise description, not all constituent units of the display device are presented in embodiments of the present disclosure. In order to implement the basic functions of the display device, those skilled in the art can provide and set other structures not shown as desired, which is not limited in embodiments of the present disclosure.

As to the technical effects of the display device provided in the above-described embodiments, technical effects of the display substrates provided in embodiments of the present disclosure may be referred to, which will not be described in detail any more.

At least one embodiment of the present disclosure further provides a manufacturing method of a display substrate. FIG. 7 shows a flow chart of a method for manufacturing a display substrate. For example, the manufacturing method may be used to manufacture the display substrate provided in any of the embodiments of the present disclosure. For example, the method may be used to manufacture the display substrate shown in FIG. 4B. As shown in FIG. 7, the manufacturing method of the display substrate includes step S110 through step S140.

Step S110: providing a base substrate.

Step S120: forming a pixel array on the base substrate.

Step S130: forming a first conducting layer on the base substrate, and forming a plurality of gate lines and a plurality of first touch electrodes extending in the first direction with one patterning process on the first conducting layer.

Step S140: on a side of the plurality of first touch electrodes that is away from the base substrate, forming a plurality of second touch electrodes extending in the second direction crossing the first direction and intersecting the plurality of first touch electrodes.

For step S110, for example, the base substrate 100 may be of for example, glass, plastic, quartz or other suitable material, which is not limited in embodiments of the present disclosure. For example, the base substrate 100 includes a display area and peripheral areas (not shown).

For step S120, the pixel array is located in the display area of the base substrate 100.

For example, the pixel array 110 includes a plurality of pixel units P arranged in an array. For example, considering the display substrate (an array substrate herein) for a liquid crystal display device as an example, the plurality of gate lines 13 and the plurality of data lines 14 intersect each other to define a plurality of sub-pixels. For example, each of the plurality of pixel units P includes red, green and blue (RGB) sub-pixels in the same row, that is, the pixel array includes a plurality of sub-pixels arranged in the first direction and the second direction. FIG. 2 shows a circuit structure diagram of an individual sub-pixel. As shown in FIG. 2, each sub-pixel includes at least one thin film transistor 111, a pixel electrode 114 and a common electrode 113. As a switch element, the thin film transistor 111 is connected with the gate line 13, the data line 14 and the pixel electrode 114 respectively and the pixel electrode 114 and the common electrode 113 form a capacitor. For example, the common electrode 113 and the common electrode line 112 are connected to receive common electrode signals. The thin film transistor 111 in turned on under the control of gate scanning signals on the gate line 13 and applies data signals on the data line 14 to the pixel electrode 114 to charge the capacitor formed by the thin film transistor 111 and the common electrode 113, thereby forming an electric field for controlling deflection of ligates.

For example, as shown in FIG. 4B, the thin film transistors 111 in the pixel array 110 may be manufactured with conventional semiconductor manufacturing process. In some examples, for example, as shown in FIG. 4B, first, the active layer 1114 of the thin film transistor 111 is formed on the base substrate; and the first passivation layer 120, the gate 1111 (connected with or formed integral with gate line 13, in the first conducting layer), the first insulating layer 130, the first terminal 1112 (e.g. source) and the second terminal 1113 (e.g. drain) (the second conducting layer) of the thin film transistor 112, the second insulating layer 150, the common electrode 113 or the second touch electrode 12, the third insulating layer 160 and the pixel electrode 114 are formed sequentially on the active layer 1114.

In some examples, the gate 1111 of the thin film transistor 111 is connected with the gate driving circuit (not shown) via the gate line 13 (e.g., connected with or formed integral with the gate 1111) to receive gate scanning signals, and the first terminal 1112 and the second terminal 1113 of the thin film transistor 111 are connected with the active layer 1114 through via holes in the first passivation layer 120 and the first insulating layer 130. For example, the first terminal 1112 of the thin film transistor 111 is connected with the data line 14 (shown in FIGS. 1 and 4A) and connected with the pixel electrode 114 through via holes in the second insulating layer 150 and the third insulating layer 160 to transmit data signals provided by the data line 14 to the pixel electrode 114 when the thin film transistor 111 is turned on under the control of the gate scanning signals, thereby generating an electric field between the pixel electrode 114 and the common electrode 113 for controlling deflection of liquid crystalline over or between them.

For example, the pixel electrode 114 and the common electrode 113 (namely the second touch electrode 12) are transparent electrodes that may use transparent metal oxide material including indium tin oxide (ITO) or indium zinc oxide (IZO).

For example, materials for the first terminal 1112, the second terminal 1113 and the gate 1111 of the thin film transistor 111, namely materials for the first conducting layer and the second conducting layer, may include aluminum, aluminum alloy, copper, copper alloy or any other suitable materials, which are not limited in embodiments of the present disclosure. For example, the plurality of first touch electrodes 11 and the plurality of gate lines 13 have the same material as the gate 1111, which will not be described any more herein.

It is to be noted that the material for the active layer may include oxide semiconductor, organic semiconductor or amorphous silicon, poly-silicon etc. For example, the oxide semiconductor includes metal oxide semiconductor such as indium gallium zinc oxide (IGZO), the poly-silicon includes low temperature poly-silicon or high temperature poly-silicon. This is not limited in embodiments of the present disclosure.

For example, materials for the first passivation layer 120, the first insulating layer 130, the second insulating layer 150 and the third insulating layer 160 may include for example inorganic insulating material such as SiNx, SiOx and SiNxOy, organic insulating material such as organic resin or other suitable materials, which are not limited in embodiments of the present disclosure.

For step S130, for example, forming a plurality of first touch electrodes 11 and a plurality of gate lines 13 extending in the first direction by one patterning process on the first conducting layer can reduce conducting layers for first touch electrodes separately, omit one manufacturing process and reduce manufacturing costs. For example, the plurality of first touch electrodes 11 and the plurality of gate lines 13 may be manufactured with conventional patterning process, which will not be described any more herein.

For example, as shown in FIG. 1, the plurality of gate lines 13 and the plurality of first touch electrodes 11 are located between rows of pixel units, that is, orthogonal projections of the plurality of gate lines 13 and orthogonal projections of the plurality of first touch electrodes on the base substrate 100 do not overlap the orthogonal projections of sub-pixels in the display area on the base substrate 100 and are located between the orthogonal projections of the sub-pixels in the display area on the base substrate 100 in the first direction, for example, located between the orthogonal projections of the pixel electrodes of the sub-pixels in the display area on the base substrate 100 in the first direction.

For step S140, in some examples, for example, the first conducting layer (namely a plurality of first touch electrodes 11 and plurality of gate lines 13) is covered by the first insulating layer 120 above, a second conducting layer (namely a plurality of data lines, a plurality of first touch routing lines 15 and a plurality of second touch routing lines 16) is formed on the first insulating layer 120, a second insulating layer 150 is formed on the second conducting layer, and a plurality of second touch electrodes 12 extending in the second direction crossing the first direction and intersecting the plurality of first touch electrodes are formed on the second insulating layer 150. For example, mutual capacitance is formed at locations where the plurality of second touch electrodes 12 intersect the plurality of first touch electrodes 11 and touch positions of a finger or stylus are determined by detecting the varying point of the mutual capacitance. For example, the first touch electrodes 11 serve as touch detection electrodes for transmitting touch detection signals; and the second touch electrodes serve as touch driving electrodes for transmitting touch driving signals.

For example, as shown in FIGS. 1 and 4B, each of the plurality of second touch electrodes covers at least two pixel units and is reused as the common electrode for the at least two pixel units.

For example, as shown in FIG. 4B, openings 101 are formed on at least one of the plurality of second touch electrodes 12. Openings 101 are at locations where at least one second touch electrode 12 intersects at least one first touch electrode 11, that is, the orthogonal projections of the openings 101 on the base substrate overlap at least partially the orthogonal projections of the at least one first touch electrode. For example, by disposing openings 101 at locations where the second touch electrodes intersect the first touch electrodes, it is possible to allow the second touch electrodes on both sides of an opening 101 to form mutual capacitance with the first touch electrode 11, thereby enhancing mutual capacitance and improving sensitivity. And the electric field associated with the mutual capacitance may exit through the openings 101 to be acted on by a finger of human or a stylus, thereby improving the sensitivity of sensing touch by the mutual capacitance, which allows accurately sensing or detecting a finger or stylus to implement touch function.

In some examples, a light blocking layer (not shown) is formed on the plurality of second touch electrodes 12. Orthogonal projections of the plurality of gate lines 13 and orthogonal projections of the plurality of first touch electrodes 11 on the base substrate 100 all fall within the orthogonal projection of the light blocking layer on the base substrate 100, and orthogonal projections of gaps between two adjacent second touch electrodes of the plurality of touch electrodes 12 on the base substrate also fall within the orthogonal projection of the light blocking layer on the base substrate 100, thereby preventing transmitted visible light from illuminating the plurality of gate lines 13, the plurality of first touch electrodes 11 and the gaps between adjacent two second touch electrodes of the plurality of second touch electrodes 12, hence avoiding influence of transmitted visible light on its performance.

In some other examples, the light blocking layer may be located on the opposed substrate facing the base substrate 100. As shown in FIG. 4C, the display substrate 1 includes a display substrate 100 and an opposed substrate 200 disposed oppositely and a liquid crystal layer 30 is provided between the base substrate 100 and the opposed substrate 200, which are combined together with e.g., sealing glue 40 to form a liquid crystal cell. The opposed substrate 200 is typically a color filter substrate on which a color filter layer including red sub-pixels R, green sub-pixels G and blue sub-pixels B may be disposed. Individual sub-pixels are separated by the light blocking layer 221 (e.g., the black matrix in display area), and the color filter layer is surrounded by the periphery black matrix 222 disposed in the periphery area.

For example, the light blocking layer 221 may include opaque materials such as metal electrodes, dark resin functioning to block light for gate lines, the plurality of first touch electrodes and gaps between two adjacent second touch electrodes of the plurality of second touch electrodes 12, thereby avoiding influence of transmitted visible light on its performance. It is to be noted that the light blocking layer may be manufactured with the patterning process in the art, which will not be described in detail herein.

For example, it is possible to form a plurality of data lines 14 extending in the second direction, a plurality of first touch electrode lines 15, a plurality of second touch electrode lines 16 and the first terminal 1112 and the second terminal 1113 of the thin film transistor 111 with one patterning process on the second conducting layer.

For example, the plurality of data lines 14 are located in said pixel array, the orthogonal projections of gaps between two adjacent second touch electrodes of the plurality of second touch electrodes 12 on the base substrate fall within the orthogonal projections of the data lines on the base substrate, thereby preventing light from the backlight under the base substrate 100 from illuminating the opposed substrate 200 through gaps between two adjacent second touch electrodes and influencing the display quality.

In some examples, as shown in FIG. 4B, each of the plurality of first touch electrodes lines 15 is connected with at least one of the plurality of first touch electrode 15 through via holes in the first insulating layer 130 to transmit touch detection signals; and each of the plurality of second touch electrode lines 16 is connected with the plurality of second touch electrodes 12 respectively through via holes in the second insulating layer 150 to transmit touch driving signals. For example, the first touch electrode lines and the second touch electrode lines are connected with the touch chip on the lower side of the base substrate (for example, in the binding area) respectively.

In some examples, for example, the orthogonal projections of the plurality of first touch electrode lines 15 and orthogonal projections of the plurality of second touch electrode lines 16 on the base substrate 100 do not overlap the orthogonal projections of sub-pixels in the display area on the base substrate, for example, do not overlap the orthogonal projections of red sub-pixels R, green sub-pixels G and blue sub-pixels B defined by intersections between the plurality of gate lines 13 and the plurality of data lines 14 shown in FIG. 4A in the display area on the base substrate 100, and are located between orthogonal projections of sub-pixels in the display area on the base substrate respectively, for example, located between orthogonal projections of pixel electrodes of the above-described sub-pixels on the base substrate 100 respectively, that is, the plurality of first touch electrode lines 15 and the plurality of second touch electrode lines 16 are located in the display area, which can further reduce the left and right rims of the display substrate.

In some other examples, a plurality of first touch electrode lines 15 and a plurality of second touch electrode lines 16 extending in the second direction are formed on the second conducting layer in peripheral areas of the base substrate 100.

In some examples, for example, the display substrate 1 further includes a binding area 17 (for electrically connecting touch chip etc.) on a side of the periphery area of the base substrate along the second direction, e.g., lower side of the display substrate.

Since the farther from the binding area, the less of lines, for example, the plurality of first touch electrode lines 15 are gradually becoming wider in the second direction away from the binding area to maintain consistent resistance of touch electrode lines away from the binding area and near the binding area and to enhance touch accuracy.

It is to be noted that in embodiments of the present disclosure, the flow of the manufacturing method of display substrate may include more or fewer operations that may be performed sequentially or in parallel. Although the flow of the manufacturing method described above includes a plurality of operations occur in a specific order, it should be understood clearly that the order of the operations is not limited thereto. The manufacturing method described above may be performed once, or be performed for many times according to certain conditions.

As to the technical effects of the manufacturing method of display substrate provided in the above-described embodiments, technical effects of the display substrates provided in embodiments of the present disclosure may be referred to, which will not be described in detail any more.

An embodiment of the present disclosure further provides a driving method of a display substrate. For example, the driving method may be used to drive the display substrate provided in any of the embodiments of the present disclosure to implement touch and display. For example, it is possible to drive the display substrate shown in FIG. 1 or 4A. The driving method includes the following steps.

In the display stage, gate scanning signals are provided to a plurality of gate lines 15, and common signals are provided to the second touch electrodes 12 to drive the display substrate 1 to display.

In the touch stage, touch driving signals are provided to the plurality of second touch electrodes 12 and received touch detection signal at the plurality of first touch electrodes 11.

For example, when the display substrate 1 is in the display stage, the plurality of second touch electrodes may serve as common electrode to receive common signals on the common signal line 112 for driving the display substrate to display; and when the display substrate 1 is in the touch stage, the plurality of second touch electrodes may receive touch driving signals for touch detection.

For example, in some examples, the touch stage may be inserted in the blanking stage between adjacent two frames of displayed images to drive the display substrate 1 to implement display function and touch function respectively. In this case, the touch report rate of the touch screen is the same as the display frame rate, for example 60 Hz. For example, in some other examples, it is also possible to insert a plurality of touch stages piecewise in a display stage of a frame of image to improve the touch report rate (e.g., up to 120 Hz). For example, the driving of the above-described display stage and touch stage may be implemented by controlling the driving timing and circuit structure of the gate driving circuit. It is to be noted that specific circuit and driving method for implementing the display and touch functions of the display substrate may be known from design methods in the art, which will not be described any more herein.

As to the technical effects of the driving method of display substrate provided in the above-described embodiments, technical effects of the display substrates provided in embodiments of the present disclosure may be referred to, which will not be described in detail any more.

There are still the following aspects to be explained.

(1) Accompanying drawings of embodiments of the present disclosure relate only to structures involved in embodiments of the present disclosure. For other structures, common designs may be referred to.

(2) Without conflicts, embodiments of the present disclosure and features in embodiments may be combined with each other to obtain new embodiments.

What have been described above are merely exemplary implementations of the present disclosure rather than limiting the scope of the present disclosure, which is determined by the appended claims.

1. A display substrate, comprising:
a base substrate;
a pixel array disposed on the base substrate;
a plurality of gate lines extending in a first direction in the pixel array;
a plurality of first touch electrodes disposed on the base substrate and extending in the first direction; and
a plurality of second touch electrodes disposed on the base substrate and located on a side of the plurality of first touch electrodes away from the base substrate, extending in a second direction crossing the first direction and intersecting the plurality of first touch electrodes;
wherein the plurality of first touch electrodes and the plurality of gate lines are disposed in a same layer.

2. The display substrate of claim 1, wherein the pixel array comprises a plurality of pixel units, and each of the plurality of second touch electrodes covers at least two pixel units and is reused as a common electrode for the at least two pixel units.

3. The display substrate of claim 2, wherein
at least one of the second touch electrodes comprise an opening disposed at a location where the at least one of the second touch electrodes intersects at least one of the first touch electrodes, and an orthogonal projection of the opening on the base substrate overlaps at least partially an orthogonal projection of the at least one first touch electrodes on the base substrate.

4. The display substrate of claim 1, further comprising a light blocking layer, wherein the light blocking layer is located on a side of the plurality of second touch electrodes away from the base substrate,
orthogonal projections of the plurality of gate lines and orthogonal projections of the plurality of first touch electrodes on the base substrate all fall within an orthogonal projection of the light blocking layer on the base substrate.

5. The display substrate of claim 4, wherein orthogonal projections of gaps between adjacent two second touch electrodes of the plurality of second touch electrodes on the base substrate also fall within the orthogonal projection of the light blocking layer on the base substrate.

6. The display substrate of claim 1, further comprising a plurality of data lines, wherein the plurality of data lines extend in the second direction in the pixel array, and are located between the plurality of second touch electrodes and the plurality of first touch electrodes in a direction perpendicular to the base substrate, wherein
orthogonal projections of gaps between adjacent two second touch electrodes of the plurality of second touch electrodes on the base substrate fall within orthogonal projections of the plurality of data lines on the base substrate, respectively.

7. The display substrate of claim 6, further comprising:
a plurality of first touch electrode lines and a plurality of second touch electrode lines, the plurality of first touch electrode lines and the plurality of second touch electrode lines being disposed in a same layer as the data lines and extending in the second direction; wherein
each of the plurality of first touch electrode lines is connected with at least one of the plurality of first touch electrodes, and
the plurality of second touch electrode lines are connected with the plurality of second touch electrodes, respectively.

8. The display substrate of claim 7, further comprising a first insulating layer and a second insulating layer; wherein
the first insulating layer is located between the plurality of first touch electrodes and the data lines in a direction perpendicular to the base substrate, and the plurality of first touch electrodes are connected with the plurality of first touch electrode lines through via holes in the first insulating layer,
the second insulating layer is located between the data lines and the plurality of second touch electrodes in the direction perpendicular to the base substrate, and the plurality of second touch electrodes are connected with the plurality of second touch electrode lines through via holes in the second insulating layer.

9. The display substrate of claim 7, wherein the base substrate comprises a display area and a periphery area, the pixel array is located in the display area, and the pixel array comprises a plurality of sub-pixels arranged in an array along the first direction and the second direction; and wherein
orthogonal projections of the plurality of first touch electrode lines and orthogonal projections of the plurality of second touch electrode lines on the base substrate do not overlap orthogonal projections of the sub-pixels in the display area on the base substrate, and are located between the orthogonal projections of the sub-pixels in the display area on the base substrate respectively.

10. The display substrate of claim 7, wherein the base substrate comprises a display area and a periphery area, the pixel array is located in the display area, and the pixel array comprises a plurality of sub-pixels arranged in an array along the first direction and the second direction; and wherein
the plurality of first touch electrode lines and the plurality of second touch electrode lines are located in the peripheral area respectively.

11. The display substrate of claim 9, wherein orthogonal projections of the plurality of gate lines and orthogonal projections of the plurality of first touch electrodes on the base substrate do not overlap orthogonal projections of the sub-pixels in the display area on the base substrate, and are located between orthogonal projections of the sub-pixels in the display area on the base substrate along the first direction respectively.

12. The display substrate of claim 10, further comprising:
a binding area located on a side of the periphery area of the base substrate along the second direction; wherein
the plurality of first touch electrode lines gradually become wider on a side away from the binding area in the second direction.

13. The display substrate of claim 7, wherein the plurality of first touch electrodes comprise a plurality of sets of first touch electrodes, each of the plurality sets of first touch electrodes comprises at least two first touch electrodes electrically connected with each other to be connected in parallel; and wherein
at least one first touch electrode of the set of first touch electrode is connected with one of the plurality of first touch electrode lines.

14. The display substrate of claim 13, wherein the pixel array comprises M rows and N columns of pixel units, the display substrate comprises Q pieces of gate lines and Q pieces of first touch electrodes, and a gate line and a first touch electrode are disposed between every two adjacent rows of pixel units;
the display substrate further comprises a plurality of dummy touch electrode lines disposed parallel with the plurality of first touch electrode lines, and each of the plurality of dummy touch electrode lines is connected with only one set of first touch electrodes, and the plurality of dummy touch electrode lines and the plurality of first touch electrode lines are disposed between columns of pixel units respectively; and
wherein Q and N are both integers greater than or equal to 2.

15. A display device comprising the display substrate of claim 1.

16. A manufacturing method of a display substrate, comprising:
providing a base substrate;
forming a pixel array on the base substrate;
forming a first conducting layer on the base substrate, and forming a plurality of gate lines and a plurality of first touch electrodes, the plurality of gate lines and the plurality of first touch electrodes extending in the first direction with one patterning process on the first conducting layer; and
on a side of the plurality of first touch electrodes that is away from the base substrate, forming a plurality of second touch electrodes extending in a second direction crossing the first direction and intersecting the plurality of first touch electrodes.

17. The manufacturing method of the display substrate of claim 16, further comprising:
forming an opening on at least one of the plurality of second touch electrodes; wherein
the opening is located at a location where the at least one of the second touch electrode and at least one of the first touch electrode intersects,
an orthogonal projection of the opening on the base substrate overlap at least partially an orthogonal projection of the at least one of the first touch electrodes.

18. The manufacturing method of the display substrate of claim 16, further comprising:
forming a light blocking layer on the plurality of second touch electrodes, wherein orthogonal projections of the plurality of gate lines and orthogonal projections of the plurality of first touch electrodes on the base substrate all fall within an orthogonal projection of the light blocking layer on the base substrate.

19. The manufacturing method of the display substrate of claim 16, further comprising:
forming successively a first insulating layer, a second conducting layer and a second insulating layer in a direction perpendicular to the base substrate and between the plurality of first touch electrodes and the plurality of second touch electrodes; and
forming a plurality of data lines, a plurality of first touch electrode lines and a plurality of second touch electrode lines with one patterning process on the second conducting layer, the plurality of data lines, the plurality of first touch electrode lines and the plurality of second touch electrode lines extending in the second direction; wherein
the data lines are located in the pixel array, and orthogonal projections of gaps between adjacent two second touch electrodes of the plurality of second touch electrodes on the base substrate fall within orthogonal projections of the data lines on the base substrate,
each of the plurality of first touch electrode lines is connected with at least one of the plurality of first touch electrodes through a via hole in the first insulating layer,
each of the plurality of second touch electrode lines is connected with the plurality of second touch electrodes through a via hole in the second insulating layer respectively.

20. (canceled)

21. A driving method of the display substrate of claim 1, comprising:
in a display stage, providing gate scanning signals to the plurality of gate lines, and providing common signals to the second touch electrodes to drive the display substrate to display; and
in a touch stage, providing touch driving signals to the plurality of second touch electrodes and receiving touch detection signals from the plurality of first touch electrodes.
